(19) United States
(12) Patent Application Publication
(10) Pub. No.: US 2019/0309703 A1
(43) Pub. Date: Oct. 10, 2019

(54) A TANK ARRANGEMENT FOR A WORKING MEDIUM IN A WHR SYSTEM

(71) Applicant: Scania CV AB, Södertälje (SE)

(72) Inventor: Thomas SEDERHOLM, Hägersten (SE)

(73) Assignee: Scania CV AB, Södertälje (SE)

(21) Appl. No.: 16/469,133

(22) PCT Filed: Nov. 30, 2017
(86) PCT No.: PCT/SE2017/051192

§ 371 Date: Jun. 12, 2019

(30) Foreign Application Priority Data
Dec. 19, 2016 (SE) 1651679-1

(51) Int. Cl. F02G 5/02; F01K 23/06

(52) U.S. Cl. CPC F02G 5/02; F01K 23/10; F01K 23/065

(57) ABSTRACT

The present invention relates to a tank arrangement for a working medium in a waste heat recovery (WHR) system. The tank arrangement comprises an extendable tank configured to receive a working medium circulating in the WHR system. The extendable tank comprises a tubular wall element designed to have an adjustable length in a longitudinal direction, a first end wall connected to a first end of the tubular wall element, a second end wall connected to a second end of the tubular wall element, and an actuator mechanism configured to provide a movement of the first end wall in relation to the second end wall in the longitudinal direction of the tubular wall element in order to adjust the volume of the extendable tank.

### CROSS-REFERENCE TO RELATED APPLICATIONS

This application is a national stage application (filed under 35 § U.S.C. 371) of PCT/SE2017/051192, filed Nov. 30, 2017 of the same title, which, in turn, claims priority to Swedish Application No. 1651679-1 filed Dec. 19, 2016; the contents of each of which are hereby incorporated by reference.

### FIELD OF THE INVENTION

The present invention relates to a tank arrangement for a working medium in a WHR system. The invention also relates to a WHR system comprising such a tank arrangement and a vehicle comprising such a WHR system.

### BACKGROUND OF THE INVENTION

A WHR system (Waste Heat Recovery System) can be used in vehicles for recovering waste thermal energy and convert it to mechanical energy or electric energy. A WHR system includes a pump which pressurizes and circulates a working medium in a closed circuit. The circuit comprises one or several evaporators where the working medium is heated and evaporated by one or several heat sources such as, for example, the exhaust gases from a combustion engine. The pressurized and heated gaseous working medium is directed to an expander where it expands. The expander generates mechanical energy which can be used to operate the vehicle or apparatuses on the vehicle. Alternatively, the expander is connected to a generator generating electric energy. The working medium leaving the expander is directed to a condenser. The working medium is cooled down in the condenser to a temperature at which it condenses. The WHR system may also comprise a tank with a variable volume used to compensate for volume changes of the working medium in the WHR system. The volume of the working medium varies with the temperature.

A conventional tank with a variable volume may comprise an outer rigid tank and an inner rubber bladder receiving liquid working medium from the WHR system. The volume of the rubber bladder and the working medium in the circuit are changed by applying a varied compressed air pressure to the inside of the rigid tank and outside of the rubber bladder. However, rubber bladders are sensitive to large internal overpressures which can cause it to burst. Furthermore, certain rubber is also incompatible with working mediums such as ethanol. EPDM rubber is, for example, not resistance to ethanol.

US 2214/0275778 shows a WHR system configured to recover heat energy from exhaust gases of a combustion engine. The WHR system comprises reservoir with a changeable volume receiving working medium from the condenser on a low pressure side of the WHR system. The receiver comprises a movable piston by which it is possible to change the filling volume of the reservoir and the quantity of the working medium circulating in the WHR system.

### SUMMARY OF THE INVENTION

The object of the present invention is to provide a tank arrangement for a working medium in a WHR system by which it is possible to compensate for volume changes as well as to control the condensation pressure in the WHR system in a relatively simple and reliable manner.

The above mentioned object is achieved by the tank arrangement according to claim 1. The extendable tank comprises a tubular wall element designed to have an adjustable length in a longitudinal direction, a first end wall connected to a first end of the tubular wall element, a second end wall connected to a second end of the tubular wall element, and an actuator mechanism configured to provide a movement of the first end wall in relation to the second end wall in the longitudinal direction of the tubular wall element in order to adjust the volume of the extendable tank. In this case, it is possible to define a specific volume of the extendable tank for each longitudinal position of the first end wall in relation to the second end wall. Further, it is very simple to adjust the volume of the extendable tank to different sizes in order to compensate for volume changes of the working medium in the WHR system. Furthermore, it is possible to adjust the pressure of the working medium on the low pressure side of the WHR system by means the actuator mechanism in a simple manner such that a desired condensation pressure is obtained in the condenser at which the WHR system has a high efficiency.

According to an embodiment of the invention, the tubular wall element is made of a flexible and non-elastic material. The flexibility of the material in the tubular wall element facilitates its property to be adjusted in a longitudinal direction. The non-elastic property of the material prevents that tubular wall element change shape when the pressure of the working medium inside the expandable tank is significantly different than the pressure of ambient air. Due to this measure, the tubular wall element will not bulge outwardly in case the working medium has a positive pressure and bulge inwardly in case the working medium has a negative pressure in relation to ambient pressure.

According to an embodiment of the invention, the tubular wall element is designed as a bellow element. A bellow element has excellent properties to be adjustable in a longitudinal direction. The bellow element may comprise a plurality of radially inner folded portions defining a minimum diameter of the bellow element, a plurality of radially outer folded portions defining a maximum diameter of the bellow element, and rigid rings connected to the radially inner folded portions and/or to the radially inner folded portions. Such rigid rings may be arranged on the outside of the radially inner folded portions of the bellow element and on the inside of the radially outer folded portions of the bellow element. Alternatively, such rigid rings may be an integrated part of said folded portions. The rigid rings stabilize the bellow element such that it maintains it shape regardless of the pressure differences between the working medium in the expandable tank and ambient air.

According to an embodiment of the invention, the walls of the expandable tank is made of a material compatible with a working medium in the form of ethanol. Ethanol has excellent properties to be used in a WHR system, which for example, recovers heat energy from exhaust gases in a vehicle. Such a material may, for example, be FKM rubber.

According to an embodiment of the invention, the second end wall comprises an opening, via which the extendable tank is flow connected to the low pressure side of the WHR system. In this case, the flow connection between the expandable tank and the low pressure side of the WHR system is arranged on the stationary second wall. The tank arrangement may comprise a rigid container enclosing the expandable tank. Such a rigid container protects the expandable tank from ambient pollutants and external forces which may damage the expandable tank. Furthermore, it prevent leakage of the pressurized working medium to the surrounding and it can be used to support the expandable tank and the movement transmission mechanism.

According to an embodiment of the invention, the actuator mechanism comprises an actuator configured to provide a linear movement of the first end wall in relation to the second end wall via a movement transmission mechanism. The actuator may be an electric motor or a power cylinder such as a pneumatic cylinder or a hydraulic cylinder. The movement transmission mechanism may be rack fixedly connected to said first end wall. Alternatively, it may be a piston rod of a power cylinder fixedly connected to said first end wall.

According to an embodiment of the invention, the tank arrangement comprises a control unit configured to estimate a suitable volume of the expandable tank and to actuate the actuator mechanism such that the first end wall is moved to a longitudinal position in relation to the second end wall at which the expandable tank obtains the estimated volume. The control unit may be configured to receive information about the temperature or the pressure of the working medium and to initiate a movement of the first end wall to a position in relation to the second end wall at which the expandable tank obtains a volume adapted to the working medium at the actual temperature. The volume of the working medium changes with the temperature and the pressure. The temperature and the volume of the working medium may be considerably higher during regular operating conditions than during an initial operating condition after a cold start of the WHR system. In this case, the expandable tank is used as an expansion tank for the working medium in the WHR system.

According to an embodiment of the invention, the control unit is configured to estimate a condensation pressure at which the WHR system obtains a high efficiency and to initiate a movement of the first end wall to a position in relation to the second end wall at which the estimated condensation pressure is obtained in the condenser. The pressure of the working medium in the expandable tank is substantially the same as the condensation pressure in the condenser. In order to maintain a high thermal efficiency of the WHR system, the control unit estimates the lowest possible pressure in the condenser during the actual operating condition. In certain cases, it is suitable to avoid negative pressure in the WHR-system by practical reasons. In the latter case, it can be desired to provide a condensation pressure just above 1 bar. The control unit may receive information about the actual condensation pressure in the condenser. In case there is a difference between the estimated pressure and the actual pressure, the control unit activates the actuator mechanism such that it provides a movement of the first end wall in a direction to a position in which the estimated condensation pressure is obtained.

### BRIEF DESCRIPTION OF THE DRAWINGS

In the following preferred embodiments of the invention are described, as examples, and with reference to the attached drawings, in which:

FIG. 1 shows a WHR system comprising an expandable tank and an actuator mechanism according to the present invention,

FIG. 2 shows a first embodiment of the actuator mechanism in FIG. 1, and

FIG. 3 shows a second embodiment of the actuator mechanism in FIG. 1.

### DETAILED DESCRIPTION OF THE INVENTION

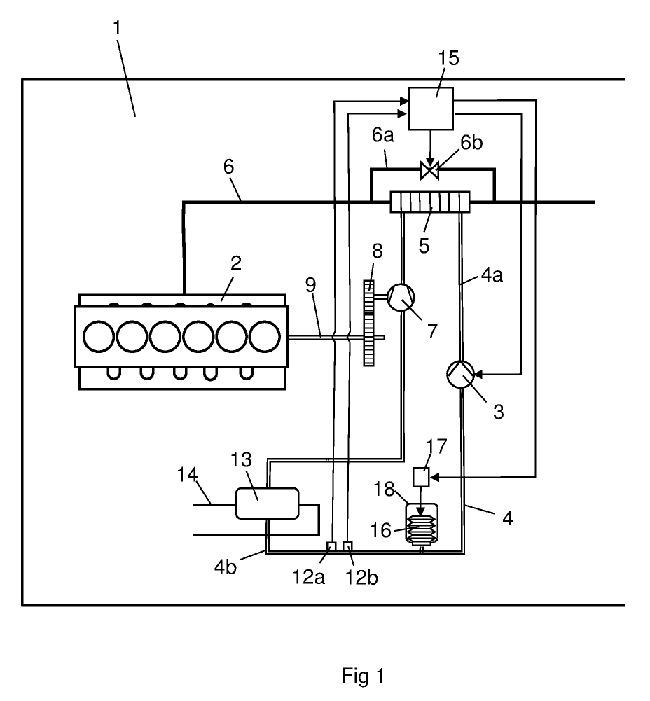

FIG. 1 shows a combustion engine 2 powering a schematically disclosed vehicle 1. The combustion engine 2 may be a diesel engine. The vehicle 1 may be a heavy vehicle. The vehicle is provided with a WHR-system (Waste Heat Recovery system). The WHR-system comprises a pump 3 which pressurizes and circulates a working medium in a closed a circuit 4. In this case, the working medium is ethanol. However, it is possible to use other kinds of working mediums such as for example R245fa. The pump 3 circulates the working medium to an evaporator 5. The working medium is heated in the evaporator 5 by exhaust gases in an exhaust line 6 from the combustion engine 2. The exhaust line 6 comprises a bypass line 6a and a valve 6b by which it is possible to direct a variable part of the exhaust gases past the evaporator 5. The exhaust line 6 may comprise further components which are not indicated in FIG. 1 such as a turbine of a turbo charger and exhaust gas treatment components. The working medium is heated in the evaporator 5 by the exhaust gases to a temperature at which it evaporates. The working medium is circulated from the evaporator 5 to an expander 7.

The pressurized and heated working medium is expanded in the expander 7. The expander 7 may be a turbine or a piston. The expander 7 generates a rotary motion which is transmitted, via a suitable mechanical transmission 8, to a shaft 9 of the power train of the vehicle 1. Alternatively, the expander 7 may be connected to a generator transforming mechanical energy into electrical energy. The electrical energy may be stored in a battery. After the working medium has passed through the expander 7, it is directed to a condenser 13. The working medium is cooled in the condenser 13 by coolant circulating in a cooling circuit 14 to a temperature at which it condenses. The coolant may have a temperature of about 70° C. The circuit has a high pressure side 4a having an extension from a position downstream the pump 3 to a position upstream the expander 7 and a low pressure side 4b having an extension from a position downstream the expander 7 to a position upstream the pump 3. A pressure sensor 12a senses the pressure and a temperature sensor 12b senses the temperature of the working medium in suitable positions on the low pressure side 4b of the WHR system. The sensed pressure corresponds to the condensation pressure in the condenser 13. A control unit receives 15 receives information from the pressure sensor 12a and the temperature sensor 12b.

The working medium is directed from the condenser 13 to an extendable tank 16. The control unit 15 controls the volume of the extendable tank 16 by means of an actuator mechanism 17. In this case, the extendable tank is arranged inside a rigid container 18. The rigid container 18 protects the extendable tank 16 from ambient pollutants and external forces that can damage the extendable tank 16. Furthermore, the rigid container 18 can prevents leakage of the pressurized working medium to the surrounding in case damage occurs to the extendable tank 16 and support the extendable tank 16 and the actuator mechanism. The pump 3 sucks working medium from the extendable tank 16 and direct it to the evaporator 5. The WHR-system makes it possible to transform thermal energy from the exhaust gases to mechanical energy or electrical energy.

During operation of the combustion engine 2, the control unit 15 receives in formation from the temperature sensor 12b about the temperature of the working medium on the low pressure side 4b of the WHR system. In view of this information, it is possible for the control unit 15 to estimate a required volume of the working medium to be accumulated in the extendable tank 16. The control unit 15 initiates activation of the actuator mechanism 17 such that it adapts the volume of the extendable tank 16 to the estimated volume. In order to maintain a high thermal efficiency of the WHR system, it is desired that the working medium is condensed at a pressure as low as possible in the condenser 13. In certain cases, it is suitable to avoid negative pressure in the WHR-system. In the latter case, it is desired to provide a condensation pressure just above 1 bar. Ethanol has a condensation temperature of 78° C. at the condensation pressure 1 bar. In case the working medium is ethanol and negative pressures are avoided, it is suitable to accomplish a condensation temperature of just above 78° C. in the condenser 13.

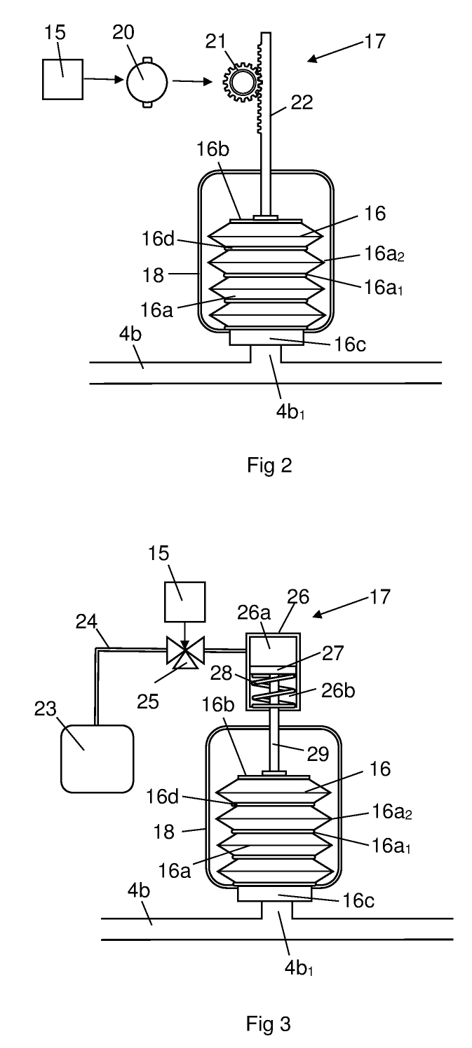

FIG. 2 shows the extendable tank 16 and the actuator mechanism 17 more in detail. Thus, the extendable tank 16 is arranged inside the rigid container 18. The extendable tank 16 comprises an inner space configured to receive liquid working medium from the low pressure side 4b of the circuit 4. The extendable tank 6 comprises a tubular wall element in the form of a bellow element 16a, a first end wall 16b connected to a first end of the bellow element 16a and a second end wall 16c connected to a second end of the bellow element 16a. The bellow element 16a is formed by a flexible material having non-elastic properties. The bellow element 16a comprises a plurality of radially inner folded portions 16a₁ defining a minimum diameter of the bellow element 16a and a plurality of radially outer folded portions 16a₂ defining a maximum diameter of the bellow element 16a. In this case, a rigid ring 16d is arranged around the radially inner folded portions 16a₁.

The second end wall 16c comprises an opening connected to a connection line 4a₁ by which the inner space of the extendable tank 16 is flow connected to the low pressure side 4b of the circuit. The actuator mechanism 17 comprises an electric motor 20 provided with a gear wheel 21 connected to a rack 22. The rack extends 22 through an opening in the rigid container 18. The rack 22 is at an end connected to the first end wall 16b of the extendable tank 16. The rack 22 and the first end wall 16b of the extendable tank 16 is movably arranged along a linear path. The second end wall is stationary arranged in the rigid container 18. The volume of the extendable tank 16 is related to the position of the first end wall 16b, which is movably arranged along said linear path in a longitudinal direction of the expandable tank 16.

During operation of the WHR system, the control unit 15 receives information from the temperature sensor 12b about the temperature of the working medium on the low pressure side 4b of the WHR system. In view of this information the control unit 15 estimates a position of the first end wall 16b at which the working medium obtains a required volume for receiving of the working medium. In case the actual position of the first end wall 16b does not corresponds to the estimated position, the control unit 15 initiates activation of the electric motor 20 such that it provides a turning movement of the gear wheel 21 at which the rack 22 moves the first end wall 16b along the linear path to the estimated position. In order to maintain a high thermal efficiency of the WHR system, it is desired that the working medium is condensed at a pressure as low as possible in the condenser 13. In certain WHR system, the condensation pressure has to be a positive pressure. However, it possible to operate the WHR system with a lower condensation pressure than 1 bar with the expandable tank 16 according to the above. The control unit 15 estimates the lowest possible condensation pressure during the actual operating condition. The control unit 15 compares the estimated condensation pressure with the actual condensation pressure. In case there is a difference, the control unit 15 initiates activation of the electric motor 20 such that it provides a turning movement of the gear wheel 21 at which the rack 22 moves the first end wall 16b along the linear path to a position in which the estimated condensation pressure is obtained. The pressure regulation movement of the first end wall 16b may be very short and it has to be provided with a high precision. The above mentioned actuator mechanism 17 makes such a movement possible.

FIG. 3 shows an alternative embodiment of the actuator mechanism 17. In this case, the actuator mechanism 17 comprises a compressed air source 23, a pneumatic cylinder 26 and a compressed air line 24 extending between the compressed air source 23 and the pneumatic cylinder 26. A three way valve 25 is arranged in the compressed air line 24. The pneumatic cylinder 26 comprises a piston 27 dividing an inner space of the pneumatic cylinder 26 in a first chamber 26a and a second chamber 26b. The first chamber 26a is configured to receive compressed air and the second chamber 26b comprises a valve spring 28. The three way valve 25 makes it possible to direct compressed air from the compressed air source 23 to the first chamber 26a of the pneumatic cylinder 26 or from the first chamber 26a to ambient air. The piston 27 is provided with a piston rod 29. The piston rod 29 extends 22 through an opening in the rigid container 18. The piston rod 29 is at an end wall connected to the first end wall 16b of the extendable tank 16. The piston rod 29 and the first end wall 16b of the extendable tank 16 is movably arranged along a linear path in the longitudinal direction of the extendable tank 16. The second end wall is stationary arranged in the rigid container 18. The volume of the extendable tank 16 is related to the position of the first end wall 16b along said linear path.

During operation of the WHR system, the control unit 15 receives in formation from the temperature sensor 12b about the temperature of the working medium on the low pressure side 4b of the WHR system. In view of this information the control unit 15 estimates a position of the first end wall 16b at which the working medium obtains a required volume for receiving of the working medium. In case the actual position of the first end wall 16b does not corresponds to the estimated position and, the control unit 15 sets the three way valve 25 in a position in which compressed air is directed to the first chamber 26a of the pneumatic cylinder 26 or in a position in which compressed air leaves the first chamber 26a of the pneumatic cylinder 26. The changed pressure in the first chamber 26a results in a linear movement of the piston 27 and the piston rod 29 which moves the first end wall 16b of the extendable tank 16 to the estimated position. After that, the control system 15 estimates a condensation pressure at which the WHR system obtains a high thermal efficiency. The control unit 15 compares the estimated condensation pressure with the actual condensation pressure. In case there is a difference, the control unit 15 sets the three way valve 25 in a position in which compressed air is directed to the first chamber 26a of the pneumatic cylinder 26 or in a position in which compressed air leaves the first chamber 26a of the pneumatic cylinder 26 such that the piston rod 29 moves the first end wall 26a along the linear path to a position in which the estimated condensation pressure is obtained. Also in this case, it is possible to move the first end wall 16b to the estimated position in which the estimated condensation pressure is obtained with a very high precision.

The invention is not restricted to the described embodiment but may be varied freely within the scope of the claims. The actuator mechanism can be designed in other ways than in the above mentioned embodiments. The actuator mechanism may, for example, comprise a hydraulic cylinder instead of a pneumatic cylinder.

1. A tank arrangement for a working medium in a waste heat recovery (WHR) system, wherein the tank arrangement comprises:
an extendable tank configured to receive a working medium circulating in the WHR system, wherein the extendable tank comprises a tubular wall element designed to have an adjustable length in a longitudinal direction, a first end wall connected to a first end of the tubular wall element, and a second end wall connected to a second end of the tubular wall element; and
an actuator mechanism comprising, an actuator and a movement transmission mechanism connected to the first end wall of the tubular wall element, wherein the actuator mechanism is configured to provide a linear movement of the first end wall in relation to the second end wall in the longitudinal direction of the tubular wall element in order to adjust the volume of the extendable tank.

2. A tank arrangement according to claim 1, wherein the tubular wall element is made of a flexible and non-elastic material.

3. A tank arrangement according to claim 1, wherein the tubular wall element is designed as a bellow element.

4. A tank arrangement according to claim 3, wherein the bellow element comprises a plurality of radially inner folded portions defining a minimum diameter of the bellow element, a plurality of radially outer folded portions defining a maximum diameter of the bellow element, and rigid rings connected to the radially inner folded portions and/or to the radially inner folded portions.

5. A tank arrangement according to claim 1, wherein the walls of the expandable tank are made of a material compatible with a working medium in the form of ethanol.

6. A tank arrangement according to claim 1, wherein the second end wall comprises an opening, via which the extendable tank is flow connected to the low pressure side of the WHR system.

7. A tank arrangement according to claim 1, wherein the actuator is an electric motor.

8. A tank arrangement according to claim 1, wherein the actuator is a power cylinder.

9. A tank arrangement according to claim 1, wherein the tank arrangement comprises a rigid container enclosing the expandable tank.

10. A tank arrangement according to claim 1, wherein the tank arrangement comprises a control unit configured to estimate a suitable volume of the expandable tank and to actuate the actuator mechanism such that the first end wall is moved to a position in relation to the second end wall at which the expandable tank obtains the estimated volume.

11. A tank arrangement according to claim 11, wherein the control unit is configured to receive information about the temperature of the working medium and to initiate a movement of the first end wall to a position in relation to the second end wall at which the expandable tank obtains a volume adapted to the working medium at the actual temperature.

12. A tank arrangement according to claim 10, wherein the control unit is configured to estimate a condensation pressure at which the WHR system obtains a high efficiency and to initiate a movement of the first end wall to a position in relation to the second end wall at which the estimated condensation pressure is obtained in the condenser.

13. A waste heat recovery (WHR) system comprising a tank arrangement for a working medium in the waste heat recovery WHR system, wherein the tank arrangement comprises:
an extendable tank configured to receive a working medium circulating in the WHR system, wherein the extendable tank comprises a tubular wall element designed to have an adjustable length in a longitudinal direction, a first end wall connected to a first end of the tubular wall element, and a second end wall connected to a second end of the tubular wall element; and
an actuator mechanism comprising an actuator and a movement transmission mechanism connected to the first end wall of the tubular wall element, wherein the actuator mechanism is configured to provide a linear movement of the first end wall in relation to the second end wall in the longitudinal direction of the tubular wall element in order to adjust the volume of the extendable tank.

14. A vehicle comprising a waste heat recovery (WHR) system comprising a tank arrangement for a working medium in the waste heat recovery WHR system, wherein the tank arrangement comprises:
an extendable tank configured to receive a working medium circulating in the WHR system, wherein the extendable tank comprises a tubular wall element designed to have an adjustable length in a longitudinal direction, a first end wall connected to a first end of the tubular wall element, and a second end wall connected to a second end of the tubular wall element; and
an actuator mechanism comprising an actuator and a movement transmission mechanism connected to the first end wall of the tubular wall element, wherein the actuator mechanism is configured to provide a linear movement of the first end wall in relation to the second end wall in the longitudinal direction of the tubular wall element in order to adjust the volume of the extendable tank.

15. A waste heat recovery (WHR) system according to claim 13, wherein the tubular wall element of the tank arrangement is made of a flexible and non-elastic material.

16. A waste heat recovery (WHR) system according to claim 13, wherein the tubular wall element of the tank arrangement is designed as a bellow element.

17. A waste heat recovery (WHR) system according to claim 13, wherein the bellow element of the tank arrangement comprises a plurality of radially inner folded portions defining a minimum diameter of the bellow element, a plurality of radially outer folded portions defining a maximum diameter of the bellow element, and rigid rings connected to the radially inner folded portions and/or to the radially inner folded portions.

18. A vehicle according to claim 14, wherein the tubular wall element of the tank arrangement is made of a flexible and non-elastic material.

19. A vehicle according to claim 14, wherein the tubular wall element of the tank arrangement is designed as a bellow element.

20. A vehicle according to claim 14, wherein the bellow element of the tank arrangement comprises a plurality of radially inner folded portions defining a minimum diameter of the bellow element, a plurality of radially outer folded portions defining a maximum diameter of the bellow element, and rigid rings connected to the radially inner folded portions and/or to the radially inner folded portions.
